(19) United States
(12) Patent Application Publication
(10) Pub. No.: US 2009/0255049 A1
(43) Pub. Date: Oct. 15, 2009

(54) BATHING INSTALLATION CONTROL WITH RFID/CARD READER/BIOMETRIC SCANNER

(76) Inventor: Paul Rosenau, Santa Ana, CA (US)

Correspondence Address: LAW OFFICES OF LARRY K. ROBERTS, INC., 2 Park Plaza, Suite 300, Irvine, CA, 92614, US

(21) Appl. No.: 12/100,937

(22) Filed: Apr. 10, 2008

(51) Int. Cl. A47K 3/02; H04Q 5/22

(52) U.S. Cl. 4/584; 340/10.1

(57) ABSTRACT

A bathing installation system includes a water receptacle, a plurality of electrically powered devices, and an electronic control system adapted to control operation of the devices. A sensor senses the presence of a personalized mobile information bearing device, the sensor having an output signal coupled to the electronic control system for indicating the sensed presence or absence of the mobile device. The electronic control system is responsive to the sensor output signal to be placed in a first state when the sensor signal indicates the sensed presence of the mobile device, and to be placed in a second state when the sensor signal indicates the absence of the mobile device.

### BACKGROUND

Typical bathing installations such as spa systems employ a control system that operates the spa equipment and a control panel that allows the user to input user commands and data. Some programming features may be programmed by the user with the control panel, e.g., filter cycles, temperature settings, lighting settings, panel and/or temperature locking. Specific buttons on the control panel are actuated to operate the equipment, or to program features.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a diagrammatic view of an exemplary spa installation, with enhanced security and control features.

FIG. 2 is a diagrammatic view of an exemplary embodiment of a transponder or tag for activating features of the spa installation of FIG. 1.

FIG. 3 diagrammatically illustrates an exemplary embodiment of a card key with a bar code for activating features of the spa installation of FIG. 1.

FIG. 4 diagrammatically illustrates an exemplary embodiment of a finger print scanner for activating features of the spa installation of FIG. 1.

FIG. 5 is a schematic block diagram of an exemplary embodiment of a spa installation.

FIG. 6 illustrates an exemplary control method RFID use with a spa, pool or other bathing installation.

FIG. 7 illustrates an exemplary control method employing bar code or other optical code control with a bathing installation such as a spa or hot tub.

FIG. 8 illustrates an exemplary method employing a finger print or other biometric scanner with a bathing installation such as a spa or hot tub.

FIG. 9 depicts a flow diagram of an exemplary production technique employing an RFID tag to facilitate production.

### DETAILED DESCRIPTION

In the following detailed description and in the several figures of the drawing, like elements are identified with like reference numerals. The figures are not to scale, and relative feature sizes may be exaggerated for illustrative purposes.

An exemplary embodiment of a bathing installation 200 is illustrated in FIG. 1. In this exemplary embodiment, the bathing installation is a spa system, but other exemplary bathing installations may include a pool installation, including a large municipal or school pool installation, or a whirlpool bath installation. The spa system 200 includes a spa tub 202, and an electronic spa control system 206 for controlling the spa systems and features, including, for example, a spa water heater 212, pump, air blower (the water pump and blower are not shown in FIG. 1) and spa operated accessories including yard or decorative lighting 210. The spa system includes a spa cover 204, which may be locked in a closed position by an electronically-controlled cover lock system 214. A control panel 216 may be situated adjacent to or supported by the spa tub to provide user interaction with the control system 206 to set parameters, and initiate some activities.

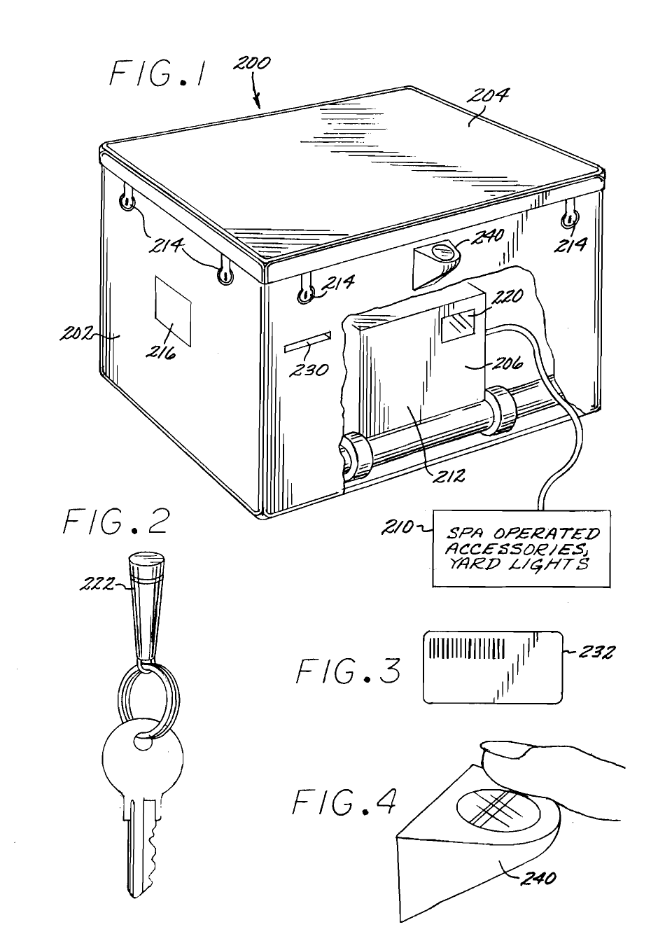

The spa control system may include one or more personalized mobile information bearing devices whose sensed presence or absence may enable features of the spa system to be activated. The personalized mobile information bearing device may be sensed or read by a sensor or reader comprising the control system. In one exemplary embodiment, the sensor is a Radio Frequency Identification (RFID) reader or sensor 220 that can interact with a mobile RFID tag 222 (FIG. 2) as the personalized mobile information bearing device. In other embodiments, the personalized mobile information bearing device may be a card or a biometric characteristic of a user, such as a thumb or finger print or an eye.

The RFID tag 222 is encoded with information which may be read by the sensor 220 when the tag is within range of the sensor 220. The information may be read and interpreted by the sensor or the control system. The RFID tag may be a passive, active, or semi-passive RFID device. For some bathing installation applications, it may be preferred to use an RFID tag with a limited range so that the RFID tag must be within a few feet of the sensor 220 for the tag information to be read by the sensor.

The coded information carried by the RFID tag is programmed or stored in a memory of the spa control system, e.g. in a location which identifies a given set of coded information as an authorized user of the spa installation. The RFID tag may be used in conjunction with the spa control system so that the sensed presence or absence of the RFID tag inside a certain distance from the spa control system will cause or allow certain spa functions to operate. These functions may include one or more of the following functions.

Security Functions:

1. The cover locks 214 automatically unlock when the RFID tag 222 is present.

2. The control panel 216 will unlock, i.e. be rendered responsive to user inputs on the control panel, when the RFID tag is present.

3. The control panel 216 is locked when the RFID tag is removed from the spa area.

4. The cover locks 214 are armed when the RFID tag is removed from the area.

5. A cover alarm is armed when the RFID tag is not present, so that an alarm will be sounded, broadcast, or signaled when the cover is opened and the RFID tag is not present.

Product Use:

1. Configurations may be stored in the system controller memory, and which run when the RFID tag is present. For example, these configurations can be programmed so that, when the RFID tag is present, the jets, light and blower will activate automatically. These activities are exemplary, and other programmed activities that are available to the spa can be programmed to activate when the RFID tag is present.

2. Different RFID tags can be associated with different programmed activities and for different preset actions, e.g. one RFID tag for daytime activities, a second RFID tag for night time activities, a third RFID tag for a parent, and a fourth RFID tag for children. Each tag has encoded therein a different code.

Automatic Shutdown:

1. The spa controller may be programmed to shut down some or all equipment when the RFID tag is removed from the spa area. Some equipment may not be shut down when the RFID tag is removed; for example, in many applications, the circulation pump would not be disabled, or a low speed pump will continue to operate for a pre-determined filtration time. Examples of equipment that would be shut down include jets, lights, blowers mist sprayers, televisions, audio systems and other ancillary devices,

2. Some items such as the yard lighting may have a separate timer so that the yard lighting will turn off after the user has had an opportunity to return to the house.

Inventory Control:

Manufacturers of spas can use the RFID tags to manage inventory while the spa is in production. An RFID Tag may be attached to an inventory item and information about that item stored in the tag (order number, part number, serial number, date code, etc.) This allows a speedy inventory count to be made by walking an RFID scanner down a row of items with RFID Tags attached. RFID tags may also facilitate the tracking of high-value items through a supply chain or delivery system.

In another exemplary embodiment, the personalized mobile information bearing device may be a card encoded with information. The spa system may include a card reader 230, including a receptacle into which a card (a mobile information bearing device) with a bar code or magnetic code strip may be inserted for reading. FIG. 3 depicts an exemplary bar code card 232 which may carry a code, e.g. a bar code, which is stored in memory of the spa control system 206. The cards could alternatively utilize magnetic strips such as hotel room keys, or even a punch card with holes to create the codes. The card 232 may be carried by an authorized user of the spa system, and by recognizing the code carried by the card 232, the spa control system may activate features of the spa system.

Alternatively or in addition to the card reader 230, the spa system 200 may also include a biometric scanner 240, e.g. a scanner such as a finger print scanner or a retinal scanner (FIG. 4). In this embodiment, the user's body, e.g. the user's digit or eye in the case of a retinal scanner, serves as the mobile information bearing device. A user may enter his biometric information during a programming mode, and the scanner 240 may be used to activate features of the spa system. The card reader and fingerprint scanner may be alternatives to the RFID tags.

In the case of a card reader 216, the card 232 may be left in the reader while the spa is being used. Removal of the card may be interpreted by the spa controller in the same manner as removal of an RFID tag from the spa area, e.g. to activate an automated shutdown of spa features. Each card 232 has a unique bar code that could be activated and programmed into the control system in the same fashion as an RFID tag. In other words, the RFID tag ID and the bar code would then be recognized by the spa control system; this code allows a certain behavior of the spa system.

The biometric scanner is somewhat different in that a finger or eye cannot be left in place by the spa user during spa use. In that case, a control system timer may be started (e.g., 2 hours, 4 hours, 6 hours, etc.) that would allow the spa to function during for that time after a successful biometric scan. The use of such a timer may also be employed with other types of personalized information bearing devices, including the RFID tag and the encoded card. Multiple unique fingerprint or retinal scans could be authorized to activate features of the spa system.

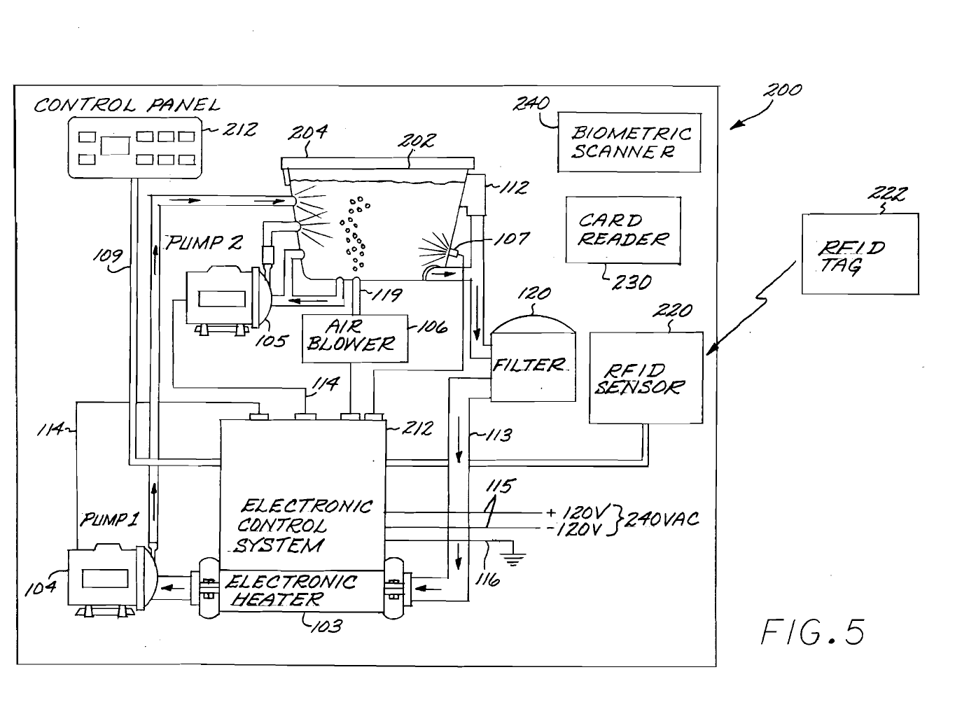

FIG. 5 illustrates an overall block diagram of an exemplary embodiment of a spa system 200. The system includes a spa tub or receptacle 202 for bathing water, and a control system 212 to activate and manage the various parameters of the spa. Connected to the spa tub 202 through a series of plumbing lines 113 are pumps 104 and 105 for pumping water, a skimmer 112 for cleaning the surface of the spa, a filter 120 for removing particulate impurities in the water, an air blower 106 for delivering therapy bubbles to the spa through air pipe 119, and an electric heater 103 for maintaining the temperature of the spa at a temperature set by the user or control system. The heater 103 in this embodiment is an electric heater, but a gas heater can be used for this purpose also. Generally, a light 107 is provided for internal illumination of the water.

Service voltage power is supplied to the spa control system at electrical service wiring 115, which can be 120V or 240V single phase 60 cycles, 220V single phase 50 cycles, or any other generally accepted power service suitable for commercial or residential service. An earth ground 11 6 is connected to the control system and there through to all electrical components which carry service voltage power and all metal parts. Electrically connected to the control system through cable 109 is the control panel 212. All components powered by the control system are connected by cables 114 suitable for carrying appropriate levels of voltage and current to properly operate the spa.

Water is drawn to the plumbing system generally through the skimmer 112 or suction fittings 11 7, and discharged back into the spa through therapy jets 11 8.

An RFID sensor or reader 220 is connected to the control system 212 to provide a sensor signal which indicates whether the RFID tag 222 is within a localized spa area. As discussed above, the sensor 220 may be replaced or supplemented with a card key scanner 230 or biometric scanner 240.

The particular equipment for a spa installation will depend on the particular implementation, and not all devices illustrated in FIG. 5 may be installed for some implementations.

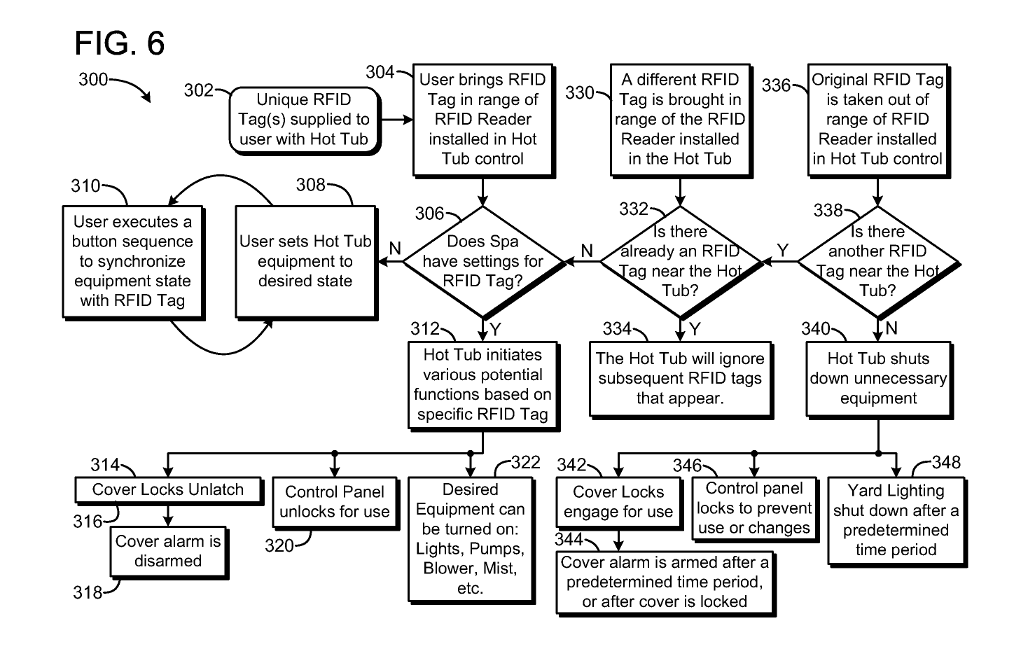

FIG. 6 illustrates an exemplary method 300 employing RFID control with a bathing installation such as a spa or hot tub. At 302, one or more unique RFID tags are supplied to a user, e.g. with the spa. At 304, the user brings the RFID tag in range of the RFID sensor or reader device installed in the spa control system, and the unique code of the RFID tag is read and provided to the spa controller. At 306, the spa controller determines whether the spa has settings for the RFID tag. If not, the user sets the spa equipment to the desired states at 308. For example, the settings for heat, air pumps, lights, and blower may be set by the user as desired. The user will then execute a button sequence at 31 0 to instruct the spa controller to synchronize the spa equipment settings with the RFID tag. These settings are stored in memory in association with the code or identification data of the RFID tag.

If at 306, the spa controller has stored settings associated with the RFID tag, then at 312, the controller will initiate various functions based on the specific RFID tag and its stored settings. At 314, the spa tub cover lock is unlatched by the spa controller, and at 318, the cover alarm (if the spa installation is equipped with a cover and alarm) is disarmed. At 320, the spa control panel is unlocked for use. At 322, the user can turn on the desired spa associated equipment, e.g., lights, pumps, blowers, misters etc.

Still referring to FIG. 6, now consider that a different RFID tag with its own unique code is brought into range of the RFID sensor at 330. If the controller determines at 332 that another RFID tag is already in range of the RFID sensor, the controller will ignore subsequent RFID tags that may come into range of the sensor. If at 332, no other RFID tags are in range, operation proceeds to 306.

At 336 (FIG. 6), the original RFID tag is taken out of range of the RFID sensor. If the controller determines at 338 that another RFID tag is within range of the sensor, operation proceeds to 332. If no other RFID tag is within range, then at 340, the spa controller shuts down unnecessary equipment, e.g., spa lights, pumps, blowers and misters. At 342, the spa tub cover lock is engaged, and at 344 the cover alarm is armed after a predetermined time period or after the cover is locked. At 346 the spa control panel is locked electronically to prevent use or changes in settings. At 348, the yard lighting associated with the spa is shut down after a predetermined time period, e.g. a delay which allows the user to walk from the vicinity of the spa to the nearby residence, or to exit a gate associated with the spa.

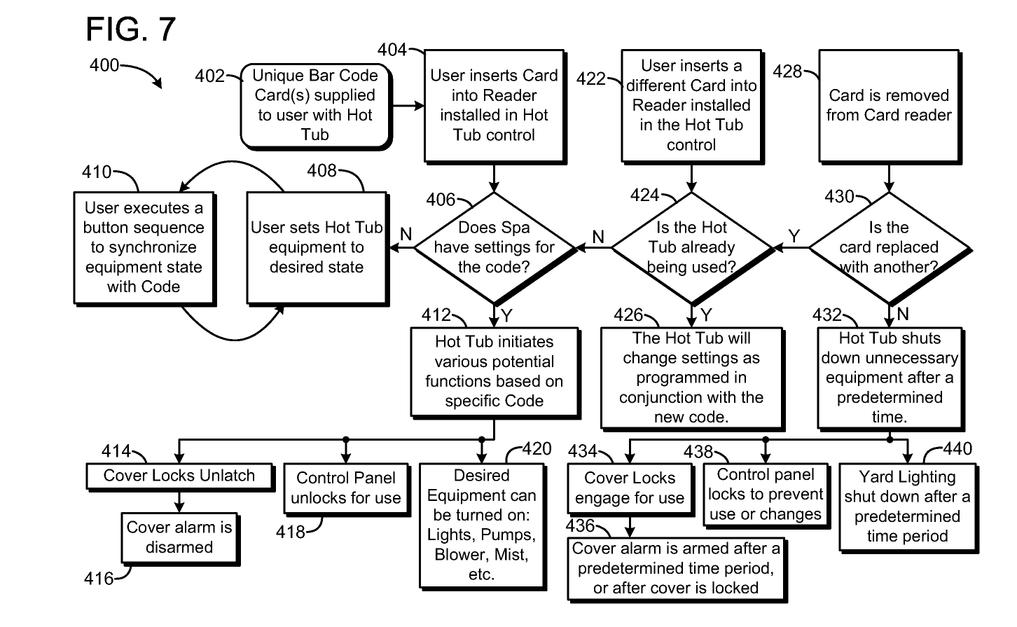

FIG. 7 illustrates an exemplary method 400 employing bar code or other optical or magnetic code control with a bathing installation such as a spa or hot tub. At 402, one or more unique code cards are supplied to a user, e.g. with the spa. At 404, the user inserts the card into the card reader installed in the spa control system, and the unique code of the card is read and provided to the spa controller. At 406, the spa controller determines whether the spa has settings for the inserted card. If not, the user sets the spa equipment to the desired states at 408. For example, the settings for heat, air pumps, lights, and blower may be set by the user as desired. The user will then execute a button sequence at 410 to instruct the spa controller to synchronize the spa equipment settings with the inserted card and its code. These settings are stored in memory in association with the code or identification data of the inserted card.

If at 406, the spa controller has stored settings associated with the inserted card, then at 412, the controller will initiate various functions based on the specific inserted card and its stored settings. At 414, the spa tub cover lock is unlatched by the spa controller, and at 416, the cover alarm (if the spa installation is equipped with a cover and alarm) is disarmed. At 418, the spa control panel is electronically enabled or unlocked for use. At 420, the user can turn on the desired spa associated equipment, e.g., lights, pumps, blowers, misters etc., allowing the spa to be controlled manually if desired by the user.

Still referring to FIG. 7, now consider the event that a different card with its own unique code is placed in the card reader at 422. If the controller determines at 424 that the spa is already in use, and the controller has settings for the different card, the controller will change the spa settings to those programmed for the new card code. If at 424, no other card is in use or the controller does not have settings for the different card, operation proceeds to 406.

At 428 (FIG. 7), the original card is removed from the card reader. If the controller determines at 430 that the card has been replaced with another card, operation proceeds to 424. If the original card has not been replaced in the reader, then at 432, the spa controller shuts down unnecessary equipment, e.g., spa lights, pumps, blowers and misters, after a predetermined time delay. At 434, the spa tub cover lock is engaged, and at 436 the cover alarm is armed after a predetermined time period or after the cover is locked. At 438 the spa control panel is locked electronically to prevent use or changes in settings. At 440, the yard lighting associated with the spa is shut down after a predetermined time period, e.g. a delay which allows the user to walk from the vicinity of the spa to the nearby residence, or to exit a gate associated with the spa.

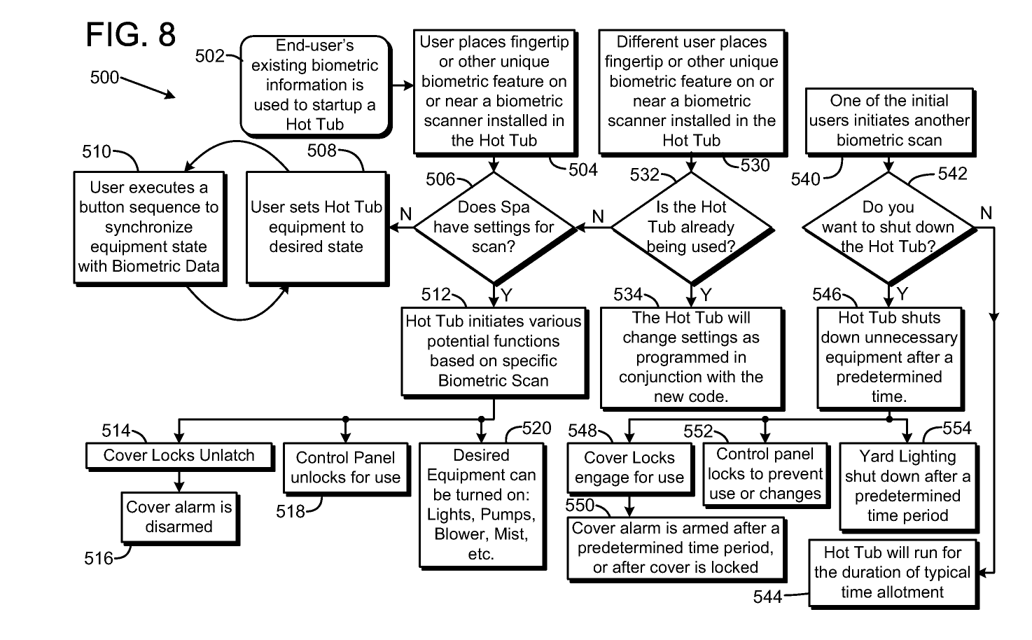

FIG. 8 illustrates an exemplary method 500 employing a finger print or other biometric scanner with a bathing installation such as a spa or hot tub. At 502, the end user's existing stored biometric information is used to startup the spa. The user places his or her fingertip or other unique biometric feature on or near a biometric scanner installed at the spa installation. At 506, the spa controller determines whether the spa has settings for the scanned biometric information. If not, the user sets the spa equipment to the desired states at 508. The user will then execute a button sequence on the spa control panel at 51 0 to instruct the spa controller to synchronize the spa equipment settings with the user's scanned biometric data. These settings are stored in memory in association with the user's biometric data scanned at 504, for use the next time the user attempts to use the spa. In an exemplary embodiment, a security feature will be applied, to control the number or identity of persons allowed to store their biometric data in the spa controller. That feature may be set for a limited period of time, or disabled completely, by an authorized user. For example, an authorized user may enter a command, opening the spa to entry of new users, for a limited time, after which time, new users are blocked for entering biometric data as an authorized user.

If at 506, the spa controller has stored settings associated with the scanned biometric data, then at 512, the controller will initiate various functions based on the specific inserted card and its stored settings. At 514, the spa tub cover lock is unlatched by the spa controller, and at 516, the cover alarm (if the spa installation is equipped with a cover and alarm) is disarmed. At 518, the spa control panel is electronically enabled or unlocked for use. At 520, the spa associated equipment, e.g., lights, pumps, blowers, misters etc. that are associated with the stored biometric data are activated by the controller. The user can also set the spa to other settings if desired, since the control panel has been unlocked for use.

Still referring to FIG. 8, now consider that a different user places his finger tip or other biometric feature on or near the biometric scanner at 530. If the controller determines at 532 that the spa installation is already in use, the controller will change the spa settings to those programmed for the different user, at 534. If at 532, the spa is not in use, operation proceeds to 506.

At 540 (FIG. 8), one of the initial users initiates another biometric scan. At 542, the controller queries the user (by interaction using the control panel, e.g. a display and control buttons, for example) to determine if the user wishes to shut down the spa. If the response is negative, the spa installation will continue to run for the duration of a time allotment, either one which is predetermined, or set by the user, and then shut down. If the user does want to shut down the spa operation, then at 546, the spa controller shuts down unnecessary equipment, e.g., spa lights, pumps, blowers and misters, after a predetermined time delay. At 548, the spa tub cover lock is engaged, and at 550 the cover alarm is armed after a predetermined time period or after the cover is locked. At 550 the spa control panel is locked electronically to prevent use or changes in settings. At 552, the yard lighting associated with the spa is shut down after a predetermined time period, e.g. a delay which allows the user to walk from the vicinity of the spa to the nearby residence, or to exit a gate associated with the spa. If no biometric scans are performed within a time period, either preset or programmed by the user, then the controller will shut down non-essential operations of the spa.

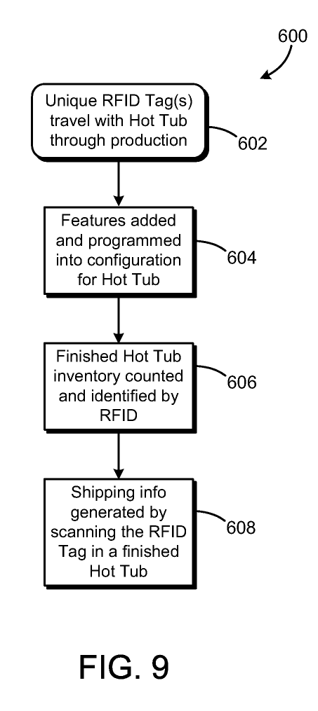

FIG. 9 is a flow diagram illustrating a method 600 utilizing an RFID tag for facilitating tracking of a spa or hot tub during and following production. The RFID tag may be attached to the hot tub and information about that item stored in the tag (order number, part number, serial number, date code, etc.). The RFID tag may be the same RFID tag which will be used to control access to the spa once it is installed, or it may be a different tag. The RFID tag travels with the hot tub or spa during production (602). Features can be added to the hot tub or hot tub and programmed into the configuration (604). Once the hot tub is completed, it may be counted, and identified by its RFID tag (606). Shipping information can be generated by scanning the RFID tag (608).

Although the foregoing has been a description and illustration of specific embodiments of the subject matter, various modifications and changes thereto can be made by persons skilled in the art without departing from the scope and spirit of the invention as defined by the following claims.

What is claimed is:

1. A bathing installation system, comprising:
a water receptacle;
a plurality of electrically powered devices;
an electronic control system adapted to control operation of the devices;
a sensor for sensing the presence of a personalized mobile information bearing device, the sensor having an output signal coupled to the electronic control system for indicating the sensed presence or absence of the mobile device;
the electronic control system responsive to the sensor output signal to be placed in a first state when the sensor signal indicates the sensed presence of the mobile device, and to be placed in a second state when the sensor signal indicates the absence of the mobile device.

2. The system of claim 1, wherein the bathing installation further includes a control panel adapted for user entry of commands and programming instructions, and wherein said control panel is locked during said second state so that the control system is not responsive to user entry of said commands and programming instructions, and the control panel is unlocked during said first state so that the control system is responsive to user entry of said commands and programming instructions.

3. The system of claim 1, further comprising a movable water receptacle cover and an electronically controlled cover lock system, and wherein the cover lock system is set to an unlocked state during said first state, and said cover lock system is set to an armed state during said second state.

4. The system of claim 1, further including a cover alarm system adapted to generate an open cover alarm when the system is set to an armed state and the cover is opened, and wherein said cover alarm system is set to the armed state in said second state.

5. The system of claim 1, wherein the control system has a memory in which is stored a spa operational configuration which automatically is activated when the mobile device is sensed by the sensor.

6. The system of claim 1, wherein the control system is adapted to shut down operation of at least some of the electrically powered devices or set the device operations to a standby mode during the second state.

7. The system of claim 1, wherein said mobile device is a Radio Frequency Identification (RFID) tag, and said sensor is an RFID sensor.

8. The system of claim 1, wherein said mobile device is a card device and said sensor is a card reader.

9. The system of claim 1, wherein said sensor is a biometric sensor, and said mobile device is a human digit or eye.

10. A spa installation, comprising:
a spa water receptacle;
a plurality of electrically powered spa devices;
an electronic spa control system adapted to control operation of the spa devices;
an RFID sensor for sensing the presence within a spa area of a mobile RFID transponder, the RFID sensor having an output signal coupled to the electronic spa control system for indicating the presence or absence of the mobile RFID transponder within the spa area;
the electronic spa control system responsive to the RFID sensor output signal to be placed in a first state when the RFID sensor signal indicates the presence of the RFID transponder within the spa area, and to be placed in a second state when the RFID sensor signal indicates the absence of the RFID transponder within the spa area.

11. The installation of claim 10, wherein the spa installation further includes a control panel adapted for user entry of commands and programming instructions, and wherein said control panel is locked so that the control system is not responsive to user entry of said commands and programming instructions, and the control panel is unlocked during said first state so that the control system is responsive to user entry of said commands and programming instructions.

12. The installation of claim 10, further comprising a movable spa cover and an electronically controlled cover lock system, and wherein the spa cover lock system is set to an unlocked state during said first state, and said spa cover lock system is set to an armed state during said second state.

13. The installation of claim 10, further including a spa cover alarm system adapted to generate an open cover alarm when the system is set to an armed state and the spa cover is opened, and wherein said spa cover alarm system is set to the armed state in said second state.

14. The installation of claim 10, wherein the spa control system has a memory in which is stored a spa operational configuration which automatically is activated when the RFID transponder is present within the spa area.

15. The installation of claim 14, wherein the spa operational configuration automatically activates at least one of electrically powered spa devices.

16. The system of claim 10, wherein the spa control system is adapted to shut down operation of at least one of the electrically powered spa devices or set the device operations to a standby mode during the second state.

17. A bathing installation system, comprising:
a water receptacle;
a plurality of electrically powered devices;
an electronic control system adapted to control operation of the devices;
a biometric data sensor for sensing biometric data of a user, the sensor having an output signal coupled to the electronic control system;
the electronic control system responsive to the sensor output signal to be placed in an access state when the sensor signal indicates that biometric data has been sensed and conforms to a stored set of biometric data, the first state configured to permit use of the bathing installation system and to set the plurality of electrically powered devices to a predetermined state.

18. The system of claim 17, wherein the bathing installation further includes a control panel adapted for user entry of commands and programming instructions, and wherein said control panel is locked when the control system is not in said access state so that the control system is not responsive to user entry of said commands and programming instructions, and the control panel is unlocked during said access state so that the control system is responsive to user entry of said commands and programming instructions.

19. The system of claim 18, wherein said control system is configured to set the plurality of electrically powered devices to a standby state when the control system is not in said access state.

20. The system of claim 17, wherein said control system is configured to exit said access mode a predetermined time interval after sensing of said biometric data or after a last sensing of a command entered through a control panel of the bathing installation.
